(19) United States
(12) Patent Application Publication
(10) Pub. No.: US 2026/0214641 A1
(43) Pub. Date: Jul. 23, 2026

(54) METHOD FOR WIRELESS COMMUNICATION AND NETWORK DEVICE

(71) Applicant: QUECTEL WIRELESS SOLUTIONS CO., LTD., Shanghai (CN)

(72) Inventor: Qufang HUANG, Shanghai (CN)

(21) Appl. No.: 19/572,243

(22) Filed: Mar. 19, 2026

Related U.S. Application Data
(63) Continuation of application No. PCT/CN2024/080835, filed on Mar. 8, 2024.

(51) Int. Cl. H04W 68/02; H04W 72/232

(52) U.S. Cl. CPC H04W 68/02; H04W 72/232

(57) ABSTRACT

The present disclosure provides a method for wireless communication, and a communication device. One example method includes: receiving a first paging message from a network device, wherein the first paging message is carried in first paging search spaces, and the first paging search spaces are determined based on at least one of a capability of the terminal device or whether a cell in which the terminal device resides implements paging optimization.

### CROSS-REFERENCE TO RELATED APPLICATIONS

This application continuation of International Application No. PCT/CN2024/080835, filed on Mar. 8, 2024, the disclosure of which is hereby incorporated by reference in its entirety.

### TECHNICAL FIELD

The present disclosure relates to the field of communication technology, and in particularly, to a method for a wireless communication and a communication device.

### BACKGROUND

In a mobile communication system, when a network device needs to transmit downlink data to a terminal device in a radio resource control (RRC) idle state or an inactive state, the network device may page the terminal device, and the network device needs to transmit a page on a paging occasion (PO) corresponding to the terminal device, which detects a paging message on the corresponding PO.

However, there is no clear solution on how to increase the flexibility of paging message transmission at present.

### SUMMARY

The present disclosure provides a method for wireless communication and a network device. Aspects of the present disclosure will be illustrated below.

In a first aspect, a method for wireless communication is provided, including: receiving, by a first terminal device, a first paging message transmitted by a network device, wherein the first paging message is carried in first paging search spaces, and the first paging search spaces are determined based on a capability of the first terminal device and/or whether a cell in which the first terminal device resides implements paging optimization.

In a second aspect, a terminal device is provided, including: a receiving unit configured to receive a first paging message transmitted by a network device, wherein the first paging message is carried in first paging search spaces, and the first paging search spaces are determined based on a capability of the first terminal device and/or whether a cell in which the first terminal device resides implements paging optimization.

In a third aspect, a terminal device is provided, including: a processor, a memory, and communication interfaces. The memory is configured to store one or more programs, and the processor is configured to call the one or more programs in the memory, causing the terminal device to perform some of or all operations of the method according to the first aspect.

In a fourth aspect, a device is provided, including: a processor, configured to call programs from a memory to cause the device to perform the method according to the first aspect.

In a fifth aspect, a chip is provided, including: a processor, configured to call programs from a memory, causing a device on which the chip is mounted performs the method according to the first aspect.

In a sixth aspect, a computer-readable storage medium is provided, on which a program is stored, and the program causes a computer to perform the method according to the first aspect.

In a seventh aspect, a computer program product is provided, which comprises a program that causes a computer to perform the method according to the first aspect.

In an eighth aspect, a computer program is provided, which causes a computer to perform the method according to the first aspect.

In the present disclosure, the network device determines paging search spaces (first paging search spaces) based on the capability of the terminal device (first terminal device), and then transmits the first paging message using the first paging search spaces. This helps the network device to transmit paging based on the capability of the terminal device, thereby improving the flexibility of the network device in transmitting paging messages.

### BRIEF DESCRIPTION OF THE DRAWINGS

FIG. 1 is a system architecture diagram of a wireless communication system to which some embodiments of the present disclosure are applicable.

FIG. 2 shows the position of the PF within the DRX cycle and the position of the PO within the PF.

FIG. 3 shows a schematic diagram of the PO within the PF.

FIG. 4 is a flowchart of a communication method.

FIG. 5 is a flowchart of a communication method provided in some embodiments of the present disclosure.

FIG. 6 is a schematic diagram of a paging optimization method provided in some embodiments of the present disclosure.

FIG. 7 is a schematic diagram of another paging optimization method provided in some embodiments of the present disclosure.

FIG. 8 is a schematic diagram of another paging optimization method provided in some embodiments of the present disclosure.

FIG. 9 is a flowchart of another communication method provided in some embodiments of the present disclosure.

FIG. 10 is a flowchart of another communication method provided in some embodiments of the present disclosure.

FIG. 11 is a schematic diagram of a structure of a terminal device provided in some embodiments of the present disclosure.

FIG. 12 is a schematic diagram of a structure of a network device provided in some embodiments of the present disclosure.

FIG. 13 is a schematic diagram of a structure of a device to which some embodiments of the present disclosure can be applied.

### DETAILED DESCRIPTION OF THE EMBODIMENTS

The following will illustrate, in conjunction with the accompanying drawings, the technical solutions of the present disclosure.

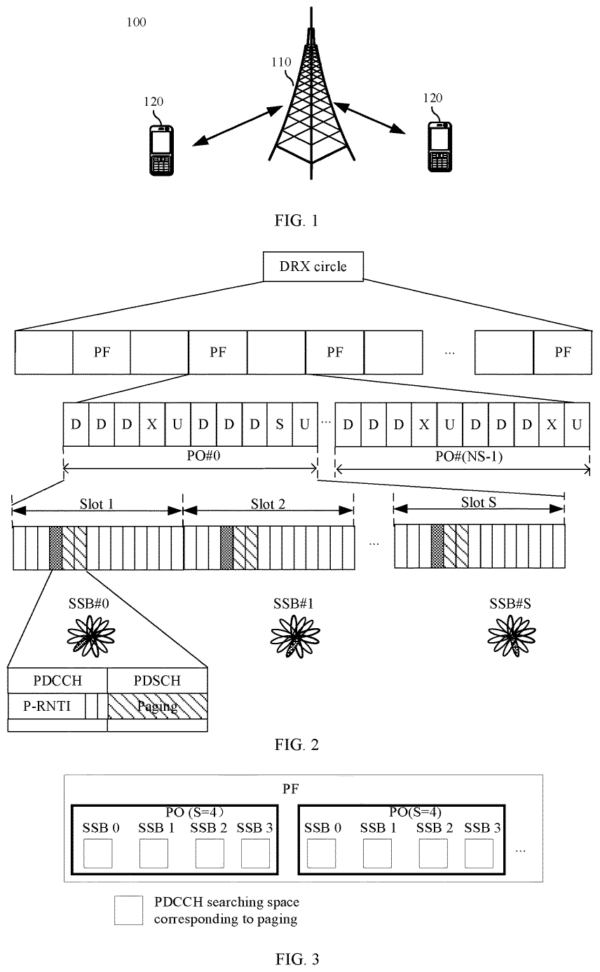

FIG. 1 shows a wireless communication system 100 to which the embodiments of the present disclosure are applied. The wireless communication system 100 may include network devices 110 and terminal devices 120. The network devices 110 may be devices that communicate with the terminal devices 120. The network devices 110 can provide communication coverage for a specific geographic area and can communicate with the terminal devices 120 located in the coverage area.

FIG. 1 exemplarily shows a network device and two terminal devices. In some embodiments, the wireless communication system 100 may include a plurality of network devices, and there may be other numbers of terminal devices located in a respective coverage area of each network device, which will not be specified in the embodiments of the present disclosure.

In some embodiments, the wireless communication system 100 may further include other network entities such as a network controller, a mobility management entity, and the like, which will not be specified in the embodiments of the present disclosure.

It should be understood that the technical solutions of the embodiments of the present disclosure may be applied to various communication systems, such as 5th generation (5G) systems or new radio (NR) systems, long term evolution (LTE) systems, LTE frequency division duplex (FDD) systems, LTE time division duplex (TDD) systems, and the like. The technical solutions provided in the present disclosure may also be applied to future communication systems, such as the sixth-generation mobile communication system, satellite communication system, and the like.

The terminal device in the embodiments of the present disclosure may be referred to as user equipment (UE), an access terminal, a user unit, a user station, a mobile station (MS), a mobile terminal (MT), a remote station, a remote terminal, a mobile device, a user terminal, a terminal, a wireless communication device, a user proxy or a user apparatus. The terminal device in the embodiments of the present disclosure may refer to a device that provides voice and/or data connectivity to a user, and can be used to communicate people, an object and a computer, such as a handheld device or a vehicle-mounted device with wireless connection function. The terminal device in the embodiments of the present disclosure may be a mobile phone, a tablet computer (Pad), a notebook computer, a palm computer, a mobile internet device (MID), a wearable device, a virtual reality (VR) device, an augmented reality (AR) device, a wireless terminal in industrial control, a wireless terminal in self-driving, a wireless terminals in a remote medical surgery, a wireless terminals in smart grid, a wireless terminal in transportation safety, a wireless terminal in a smart city, a wireless terminal in a smart home, or the like. In some embodiments, the UE may function as a base station. For example, the UE may function as a scheduling entity that provides a lateral link signal between UEs in V2X or D2D, etc. For example, a cellular phone and a car communicate with each other using lateral link signals. The cellular phone communicates with smart home devices, without relaying communication signals by a base station.

The network device in the embodiments of the present disclosure is a device configured to communicate with a terminal device, which may also be referred to as an access network device or a wireless access network device, for example, the network device may be a base station. The network device in the embodiments of the present disclosure may refer to a radio access network (RAN) node (or device) that provides access to a wireless network for a terminal device. The base station may broadly cover the following names, or be a substitute for the following names, such as Node B, evolved NodeB (eNB), next generation NodeB (gNB), a relay station, an access point, a transmitting and receiving point (TRP), a transmitting point (TP), a master eNodeB (MeNB), a secondary eNodeB (SeNB), a multi-standard radio (MSR) node, a home base station, a network controller, an access node, a wireless node, an access point (AP), a transmitting node, a transceiver node, a base band unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or a combination thereof. A base station may also be a communication module, a modem or a chip arranged in the aforementioned equipment or devices. The base station may also be a mobile switching center, a device that serves as a base station in device-to-device (D2D) communication, vehicle-to-everything (V2X) communication, machine-to-machine (M2M) communication, a network-side device in 6G network, and a device that serves as a base station in future communication systems. The base station can support networks using the same or different access technologies. The specific technology and equipment form adopted by the network device are not limited in the embodiments of the present disclosure.

The base station may be fixed or mobile. For example, a helicopter or a drone may be configured as a mobile base station, and one or more cells may move with the location of the mobile base station. In other examples, a helicopter or a drone may be configured as a device for communicating with another base station.

In some deployment, the network device in the embodiments of the present disclosure may refer to CU or DU, or the network device may include both CU and DU. gNB may also include AAU.

The network devices and the terminal devices may be deployed on land, including indoor or outdoor, handheld or vehicle boarded, or may be deployed on the water, or may further be deployed on airplanes, balloons and satellites in the air. The scenes where the network devices and the terminal devices are located is not limited in the embodiments of the present disclosure.

It should be understood that all or part of the functions of the communication devices in the present disclosure may also be implemented by the functions of software running on hardware, or by the virtualization functions instantiated on platforms (such as cloud platforms).

In the NR system, the network device may transmit a paging to a terminal in an RRC idle state or an RRC inactive state, where the paging procedure may be triggered by a core network or a base station. The paging procedure may be used to send a paging request to the terminal in the RRC idle state, or the paging procedure may also be used to notify the terminal of system information update, or the paging procedure may also notify the terminal to receive alarm information sent by an earthquake and tsunami warning system (ETWS) and a commercial mobile alert system (CMAS).

If the paging message is initiated by the core network device, after receiving the paging message sent by the core network device, the network device will interpret the contents thereof, obtain a tracking area identity (TAI) list of the paged terminal, and perform air interface paging in the cell belonging to the tracking area in the list. Generally, in order to save the overhead of transmitting paging messages, after receiving the paging messages sent by the core network device, the base station can summarize the paging messages corresponding to the terminals with the same PO into one paging message, and finally transmit it to the related terminals through the paging channel.

The paging message above is carried through a physical downlink shared channel (PDSCH). Before receiving the paging message, the terminal needs to first receive the paging parameter through the system message, and calculate the frame number of the paging frame (PF) and the PO in which the paging message is located in combination with its own UE_ID. Then, within the PO on the PF, the terminal monitors for a physical downlink control channel (PDCCH) scrambled by a paging radio network temporary identity (P-RNTI) to receive paging indication information, and finally receives the paging message based on the paging indication information.

The PF above represents the frame number of the system frame in which the paging message should appear, and the PO indicates the time at which the paging message may appear. FIG. 2 shows the position of the PF within the DRX cycle and the position of the PO within the PF. As shown in FIG. 2, the paging occasions for a UE are evenly distributed across the PFs and POs. The PF is located within the DRX cycle (or paging cycle). One PF may include one or more POs, and a plurality of POs may correspond to different terminals. However, for a terminal, during the DRX cycle, it only needs to monitor its own PO. In other words, one UE only needs to receive one paging message once within a DRX cycle.

As described above, the terminal may calculate PFs and POs based on the UE_ID. In some implementations, the system frame corresponding to the system frame number (SFN) that satisfies the formula (SFN+PF_offset)mod T=(T div N)*(UE_ID mod N) can be used as a PF. Within the PF, the index (i_s) of the PO corresponding to the terminal can be calculated according to the formula i_s=floor (UE_ID/N) mod Ns. Where T represents the cycle length of the terminal's DRX cycle; UE_ID is configured to identify the terminal; N represents the number of PFs within the DRX cycle; and Ns represents the number of POs within one PF. PF_offset represents the frame offset of the PF.

Note that, for one terminal, if the default DRX cycle is different from the DRX cycle configured for the terminal, the cycle length of the smaller DRX cycle among the two DRX cycles may be selected as the T. That is, T=min (T_UE, T_sib), where T_sib represents the cycle length of the default DRX cycle indicated in the system message, and T_UE represents the cycle length of the DRX cycle configured for the terminal. Of course, for a terminal in which T_UE is not configured, the cycle length of the default DRX cycle indicated in the system message may be used as the value of T, that is, T=T_sib.

It should also be noted that the above-described UE_ID can be calculated by the formula UE_ID=(5G-S-TMSI mod 1024), where 5G-S-TMSI represents a temporary mobile subscriber identity (TMSI) assigned to the terminal by the communication system.

Further, in the NR technique, for a terminal in the RRC idle state or the RRC inactive state, the network device does not know which transmission beam to use to transmit a paging message for the terminal. In order to ensure that the terminal can receive the paging message, the network device transmits the paging message in a beam forming manner. In order to support multi-beam transmission of paging messages, PO may be defined as a group of PDCCH monitoring occasions, and different PDCCH monitoring occasions correspond to paging indication information transmitted through different transmission beams. One PF may include one or more POs or start time points of the POs.

The PDCCH search space corresponding to the paging within one PO is notified to the UE by a system message, as shown in FIG. 3. The data structure of the configuration message of the system message configuration paging search spaces corresponding to FIG. 3 is as follows:

PDCCH-ConfigCommon:: = SEQUENCE {
controlResourceSetZero ControlResourceSetZero
commonControlResourceSet ControlResourceSet
searchSpaceZero SearchSpaceZero
commonSearchSpaceList SEQUENCE (SIZE(1..4)) OF SearchSpace
searchSpaceSIB1 SearchSpaceId
searchSpaceOtherSystemInformation SearchSpaceId
pagingSearchSpace SearchSpaceId
ra-SearchSpace SearchSpaceId
}

The SearchSpace configuration information is as follows:

| | |
|---|---|
| SearchSpace ::= | SEQUENCE { |
| searchSpaceID | SearchSpaceId, |
| controlResourceSetId | ControlResourceSetId |

monitoringSlotPeriodicityAndOffset CHOICE {

| | |
|---|---|
| Sl1 | NULL, |
| sl2 | INTEER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| s1640 | INTEGER (0..639), |
| sl1280 | INTEGER (0..1279), |
| sl2560 | INTEGER (0..2559) |
| } | |
| duration | INTEGER (2..2559) |

monitoringSymbolsWithinSlot BIT STRING (SIZE (14))

| | |
|---|---|
| nrofCandidates | SEQUENCE { |
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |
| } | |
| searchSpaceType | CHOICE { |
| common | SEQUENCE { |

dci-Format0-0-AndFormat1-0 SEQUENCE {

```
          ...
        }
```

Here, controlResourceSet is configuration information of CORESET, which is a set of a group of physical resources, including a plurality of RBs in a frequency domain and a plurality of OFDM symbols in a time domain. One search space corresponds to one CORESET_id; monitoringSlotPeriodicityAndOffset defines the period of each time slot and the offset value; duration identifies the number of continuous time slots in each cycle; monitoringSymbolsWithinSlot indicates the starting symbol position in the time slot; nrofCandidates identifies the number of candidates for each type of AL configuration; and searchSpaceType indicates the search space type.

In the case where the search space identifier SearchSpaceId of the paging search spaces is 0, since each synchronization signal block (SSB) index corresponds to one PDCCH monitoring occasion, and different SSB indexes correspond to different beams, a plurality of PDCCH monitoring occasions in one PO can be associated with transmission beams corresponding to different SSB indexes to support multi-beam transmission of paging messages. Typically, the SSBs required to complete a beam sweep form an “SSB burst”.

In the case where the search space identifier SearchSpaceId of the paging search spaces is not 0, one PO includes “S*X” consecutive PDCCH monitoring occasions, where S is the number of SSBs transmitted in the PO, and is indicated by the “ssb-PositionsInBurst” field in the system information blocks (SIB1). X represents the number of PDCCH monitoring occasions corresponding to each SSB, and may be indicated by the “nrofPDCCH-MonitoringOccasionPerSSB-InPO” field of the SIB. In the case that this parameter is not configured, X is 1. For the [x*S+K]-th PDCCH monitoring occasion in one PO, corresponds to the K-th actually transmitted SSB, where x=0, 1, . . . , X−1, K=1, 2, . . . , S. For example, if S=8 and X=2, then one PO includes 16 PDCCH monitoring occasions, and the SSB index corresponding to the 16 PDCCH monitoring occasions is “0123456701234567” in chronological order, where the index numbers of the first 8 SSBs are 0-7.

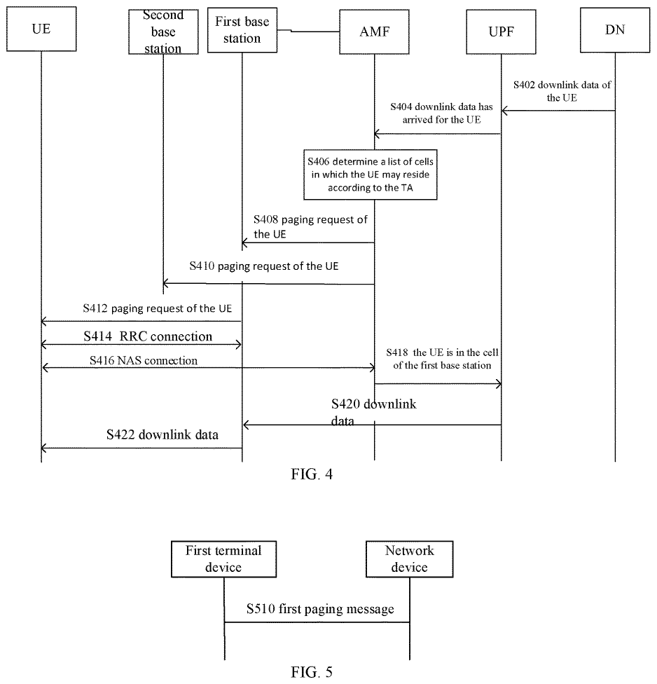

Taking the terminal equipment as a UE, the network device as a base station, and the terminal device as an IDLE state as an example, the present disclosure shows a schematic flowchart of the base station transmitting a paging message when downlink data arrives through FIG. 4.

A data network (DN) stores a user plane function (UPF) address and a port number in which the UE is located, and an access and mobility management function (AMF) stores tracking area (TA) information of the UE and capability information of the UE. Where, TA is a set of a group of cells, and the UE must reside in a certain cell in this group of cells, but the AMF does not know which cell the UE specifically resides in. The UE also stores the current TA information. Whenever the UE moves to a new cell, it reads the new cell's identifier (ID) and compares it with the cell list contained in the TA. If the new cell's ID is within the TA's cell range, no procedures are initiated. If the new cell's ID is not within the TA's cell range, a TA update procedure is initiated. Therefore, for every UE in the IDLE state, the AMF always stores valid TA information.

Referring to FIG. 4, at step S402, the DN transmits the downlink data of the UE to the UPF when the downlink data of the UE arrives.

At S404, after the downlink data arrives at the UPF, the UPF finds that there is no downlink data channel for the UE, and notifies the AMF that downlink data has arrived for the JE.

At S406, after receiving the notification, the AMF queries the TA information stored by itself, and determines a list of cells in which the UE may reside according to the TA.

At S408 and S410, the AMF sends a paging request of the UE to the cell in the list, respectively, the plurality of MF carries the identity S-TMSI assigned to the UE by the core network in the paging request.

At S412, each cell receiving the paging request sends a paging message (paging) of the UE through the wireless interface, and the specific timing of sending the paging message is calculated based on S-TMSI. Both the first base station and the second base station send paging messages in corresponding cells. Since a plurality of UEs will reside in one cell, these UEs may have paging requirements at the same time, and if the paging occasions calculated from S-TMSI of these UEs are the same, the cell may include paging for a plurality of UEs in the same paging message.

At S414, after receiving the paging message, the UE initiates an RRC connection to the cell in which it resides.

At S416, the UE establishes a NAS connection with the corresponding AMF.

At S418, the AMF notifies the UPF that the UE is in the cell of the first base station.

At S420, the AMF establishes a data channel from the UPF to the first base station to transmit downlink data.

At S422, the base station establishes a data channel from the base station to the UE to transmit downlink data.

At S412, when the base station sends the paging message to the UE, since the base station does not determine where the UE is located. To ensure that the UE can receive the paging message anywhere within the cell, the base station uses beam forming. This means the base station can send the paging message in different directions. For example, the base station sends S paging messages within the same PO, corresponding to SSB0, SSB1 and SSB (S−1), respectively. The value of S is the same as the number of SSBs in the cell, and the contents of these SSBs are exactly the same.

As mentioned above, the PDCCH search space corresponding to the paging within one PO is notified to the terminal device by a system message. After receiving the system message, the terminal device determines the paging search spaces according to the system message. Then, according to the number S of SSBs in the cell, every S paging search spaces form one PO, and the terminal device monitors for paging in the PO. In this way, it can be guaranteed that paging messages sent within one PO can be sent to any location within the cell coverage.

Accordingly, according to the SSB measurement result, the terminal device determines the SSB with the best reception effect in its own position, and blindly detects the SSBs in the paging search spaces corresponding to the SSBs in the POs. Since the downlink control information (DCI) for scheduling the paging message sent by the network device to the terminal device is scrambled by a paging radio network temporary identifier (P-RNTI), the terminal device can detect the DCI for scheduling the paging message of the terminal device based on the P-RNTI. If the blind detection detects the P-RNTI scrambled DCI, it receives a paging message. The data structure of the paging message includes a paging record list. The terminal device judges whether its terminal device identifier is included in the list. If it is, it considers that it has received the paging, and if it is not, it considers that it has not paged.

With the development of communication technology, the concept of network energy saving (NES) is put forward. NES can reduce the power consumption of network devices (base stations). The terminal device residing in the NES cell can support paging optimization, and the terminal device can tolerate longer paging delay. After the introduction of NES mode, there is no clear solution on how to increase the flexibility of paging message transmission.

In order to solve the above problems, the present disclosure provides a wireless communication method, in which a network device may determine paging search spaces based on the capability of the terminal device and/or whether the cell in which the terminal device resides implements paging optimization, and then send a paging message through the determined paging search spaces. Accordingly, the terminal device may determine the paging search spaces based on the capability of the terminal device and/or whether the cell in which the terminal device resides implements paging optimization, and monitor for the paging message on the corresponding paging search spaces. On the one hand, it can increase the flexibility of network device in transmitting paging messages, and on the other hand, it can reduce the power consumption of network device.

Further, in order to solve the above problem, the first terminal device may acquire first information, where the first information may be used to indicate whether the cell in which the first terminal device resides implements paging optimization. According to the above solution, the terminal device can determine the paging search spaces based on whether the cell in which the terminal device resides implements paging optimization and/or the capability of the terminal device, and monitor the paging message in the paging search spaces, thereby increasing the flexibility of the network device in transmitting the paging message.

Further, in order to solve the above problem, the first terminal device may send first capability information to the network device, and the first capability information may be used to indicate whether the terminal device supports paging optimization. According to the above solution, the network device can determine the paging search spaces based on the capability of the terminal device and/or whether the cell in which the terminal device resides implements paging optimization, and send the paging message in the corresponding paging search spaces, thereby increasing the flexibility of the network device in transmitting the paging message.

Hereinafter, embodiments of the present disclosure will be described in detail. What is described below is applicable to all of the above-described solutions. In the case where there is no conflict, the various solutions of the embodiments of the present disclosure can be used in combination with each other.

FIG. 5 is a schematic flow diagram of a wireless communication method according to embodiments of the present disclosure. The method of FIG. 5 may be performed by a terminal device and a network device. The terminal device may be, for example, the aforementioned terminal device 120, and the network device may be, for example, the aforementioned network device 110.

At S510, the first terminal device receives a first paging message sent by the network device.

The network device in embodiments of the present disclosure may be a network device that supports NES features or implements paging optimization. In some embodiments, the network devices may be a network device of R19 (also referred to as Rel-19) and later devices. In some embodiments, R19 and later network devices must implement paging optimization as long as they support NES features.

The first terminal device may be any type of terminal device. For example, the terminal device may be a terminal device that supports paging optimization, or may be a terminal device that does not support paging optimization. The paging optimization in the embodiments of the present disclosure may also be replaced with the paging enhancement.

The terminal devices supporting paging optimization may include network device of R19 (also referred to as Rel-19) and later devices. Further, the terminal devices that supports paging optimization may also be a terminal device of R19 and later devices, which has indicated to the network device that it supports paging optimization or NES paging optimization. Terminal devices supporting paging optimization can tolerate a longer paging delay. Terminal devices that support paging optimization may reside within a NES cell or may communicate with a network device that supports NES features.

Terminal devices that do not support paging optimization may include terminal devices prior to R19, and such terminal devices may also be referred to as ordinary terminal devices. Terminal devices that do not support paging optimization can tolerate shorter paging delays.

In some implementations, terminal devices that do not support paging optimization cannot reside within the NES cell or cannot communicate with network devices that support NES features.

The first paging message may be carried in the PDSCH. Receiving the first paging message sent by the network device by the first terminal device may mean that the first terminal device receives the PDSCH sent by the network device. The PDSCH may be scheduled by the PDCCH, or the PDCCH may be used to indicate the resource location of the PDSCH. Wherein, the PDCCH may be used to carry paging indication information. The terminal device may receive the paging message by monitoring to the P-RNTI scrambled PDCCH.

The first paging message may be carried in the first paging search spaces. By configuring the first paging search spaces for the first terminal device, the network device may transmit the first paging message only in the first paging search spaces, correspondingly, the first terminal device may monitor for the first paging message only in the first paging search spaces. In this way, both the power consumption of the network device and the power consumption of the terminal device can be saved.

It can be understood that the first paging message is carried in the first paging search spaces, which may indicate that the first PDSCH is carried in the first paging search spaces and/or the first PDCCH is carried in the first paging search spaces. Here, the first PDSCH is configured to carry a first paging message, the first PDCCH is configured to schedule the first PDSCH, or the first PDCCH is configured to indicate a resource location of the first PDSCH.

The first paging search spaces may be determined based on a capability of the first terminal device and/or whether a cell in which the first terminal device resides implements paging optimization. The first paging search spaces may be different if the capability of the first terminal device is different and/or the capability of the cell in which the first terminal device resides to implement paging optimization is different. The capabilities of the first terminal device may include supporting paging optimization and not supporting paging optimization. The ability of the cell in which the first terminal device resides to perform paging optimization may include performing paging optimization and not performing paging optimization. If the first terminal device does not support paging optimization and/or the cell in which the first terminal device resides does not implement paging optimization, the first paging search spaces may be paging search spaces determined in a conventional manner, or alternatively, the first paging search spaces may be paging search spaces determined in accordance with the solution described in the background section above. In this case, the first paging search spaces may be referred to as old paging search spaces or original paging search spaces. If the first terminal device supports paging optimization and the cell in which the first terminal device resides implements paging optimization, the first paging search spaces may be specific paging search spaces. Specific paging search spaces may also be referred to as new paging search spaces.

In the present disclosure, paging messages of terminal devices supporting paging optimization can be transmitted in specific paging search spaces. With the continuous evolution of the network, more and more terminal devices support paging optimization, while fewer and fewer do not. This reduces the number of paging messages sent by network devices using the old paging search spaces, allowing paging messages to be centralized within specific paging search spaces (or new paging search spaces), thereby reducing power consumption for network devices.

Hereinafter, a setting method of the first paging search spaces when the first terminal device supports paging optimization will be described in combination with two examples.

### Example 1

In some embodiments, the first paging search spaces may be newly added paging search spaces, and the newly added paging search spaces may be different paging search spaces from the original paging search spaces. Here, the newly added paging search spaces may be newly added paging search spaces in the first PO. The first PO may be an original PO or a newly added PO. The newly added PO may be a different PO from the existing PO. If the first PO is a newly added PO, all paging search spaces in the first PO are newly added paging search spaces. If the first PO is the original PO, the first PO may include the newly added paging search spaces and the original paging search spaces. On the basis of the existing PO, the network device may add a new PO paging search spaces for paging optimization as the newly added paging search spaces, and use the newly added paging search spaces as the first paging search spaces for transmitting the first paging message. By adding new paging search spaces, the flexibility of setting the paging search spaces can be increased.

Taking the first terminal device as an example, if the first terminal device supports paging optimization, the first paging search spaces may be newly added paging search spaces in the first PO, and the first PO may be determined based on the identifier of the first terminal device. For example, the first PO is obtained by calculation by the terminal device according to its own identifier. Exemplarily, the terminal device calculates the first PO according to its own S-TMSI identifier. After the terminal device acquiring the first PO, the terminal device can receive the paging in the newly added paging search spaces in the first PO. In some embodiments, the first PO may also be referred to as a target PO.

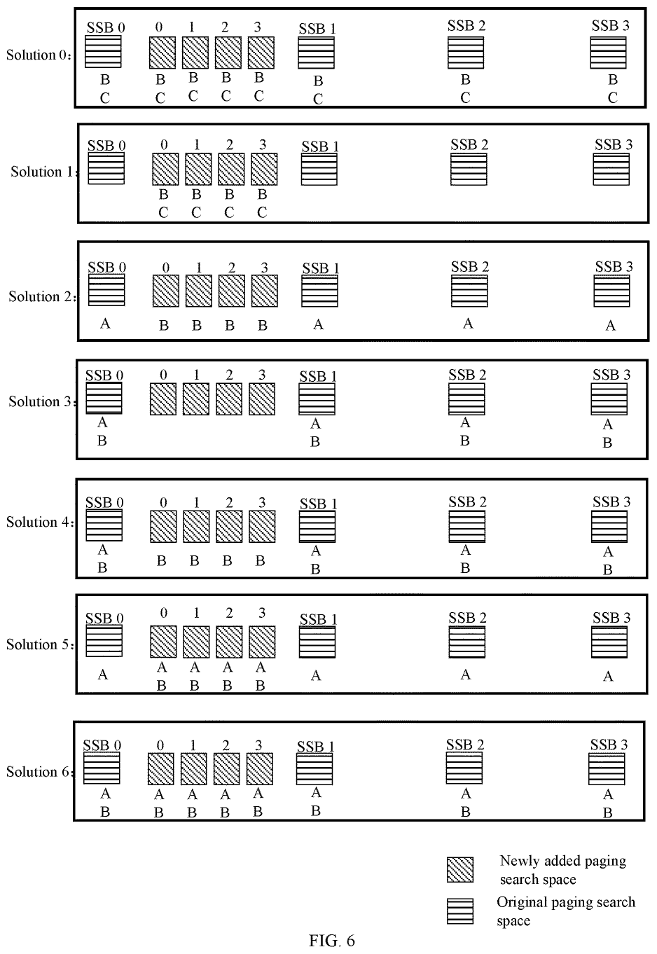

The embodiments of the present disclosure do not specifically limit the setting position of the newly added paging search spaces. As one example, the newly added paging search spaces may be arranged at any location within the first PO. As another example, the newly added paging search spaces may be disposed between a plurality of original paging search spaces in the first PO. Assuming that the original paging search spaces in the first PO include the paging search space 1, the paging search space 2, and the paging search space 3, the newly added paging search spaces may be set between the paging search space 1 and the paging search space 2, and between the paging search space 2 and the paging search space 3. As yet another example, the newly added paging search spaces may be disposed between any two original paging search spaces in the first PO. Assuming that the original paging search spaces in the first PO includes the paging search space 1, the paging search space 2, and the paging search space 3, the newly added paging search spaces may be set between the paging search space 1 and the paging search space 2, or the newly added paging search spaces may be set between the paging search space 2 and the paging search space 3. Taking FIG. 6 as an example, the newly added paging search spaces are set between SSB0 and SSB1. By setting the newly added paging search spaces between the two original paging search spaces, the time interval between the two newly added paging search spaces can be reduced, thus helping to reduce the paging delay of the terminal device. Taking solution 0 in FIG. 6 as an example, assuming that there are four SSBs in the current cell, that is, S=4. Four paging search spaces are added in this paging optimization, corresponding to SSB0 to SSB3 respectively. It can be seen from the figure that the distances between the four newly added paging search spaces are relatively close and smaller than the distances between the original four SSBs.

In addition, since the time intervals between the newly added paging search spaces are small, they can share a single measurement reference signal. Therefore, the network device only needs to send one measurement reference signal to the terminal device, and the terminal device only needs to measure the reference signal once, which can reduce the power consumption of both the network device and the terminal device. As yet another example, the newly added paging search spaces may be disposed between the first two existing paging search spaces within the first PO. Assuming that the original paging search spaces in the first PO include the paging search space 1, the paging search space 2, and the paging search space 3 in chronological order, the newly added paging search spaces may be set between the paging search space 1 and the paging search space 2. Taking FIG. 6 as an example, the newly added paging search spaces are set between SSB0 and SSB1. As yet another example, the newly added paging search spaces may be disposed between the last two original paging search spaces within the first PO. Assuming that the original paging search spaces in the first PO includes the paging search space 1, the paging search space 2, and the paging search space 3 in chronological order, the newly added paging search spaces may be set between the paging search space 2 and the paging search space 3.

In some embodiments, the time interval between any two paging search spaces of the newly added plurality of paging search spaces may be equal. As shown in FIG. 6, the time intervals between the paging search space 0, the paging search space 1, the paging search space 2 and the paging search space 3 are equal. Of course, the time interval between any two paging search spaces among the plurality of newly added paging search spaces may be different, and the embodiments of the present disclosure do not specifically limit this.

The embodiments of the present disclosure do not specifically limit the number of newly added paging search spaces. As one example, the number of newly added paging search spaces within the first PO may be equal to the number of beams of the cell. For example, if the number of beams in the cell is S, the number of newly added paging search spaces in the first PO is also S. That is, the number of newly added paging search spaces in the first PO is equal to the number of original paging search spaces in the first PO. This can ensure that any terminal equipment in any position in the cell can receive paging messages, and can also avoid waste of resources. Taking FIG. 6 as an example, if the number of original paging search spaces in the first PO is 4, and the number of SSBs in the first PO is 4, the number of newly added paging search spaces in the first PO is also 4. As another example, the number of newly added paging search spaces within the first PO may be less than the number of beams of the cell. As yet another example, the number of newly added paging search spaces within the first PO may be greater than the number of beams of the cell.

The newly added paging search spaces may be indicated to the terminal device by the network device, or may be determined by the terminal device itself according to a preset rule, or may be predefined by a protocol. For example, the newly added paging search spaces may be indicated to the terminal device by the network device, and the network device may indicate to the terminal device a time-frequency position where the newly added paging search spaces are located through a system message. For another example, the newly added paging search spaces may be predefined by the protocol, and the protocol may specify the time-frequency position where the newly added paging search spaces are located, or the protocol may specify the relative relationship between the newly added paging search spaces and the time-frequency position of the original PO.

When the first terminal device monitors paging messages, it can determine the PF and the first PO that need to be monitored according to its own identifier. Then, it can determine the newly added paging search spaces based on the indication in the system message. Alternatively, it can directly determine the newly added paging search spaces according to the prompt in the system message and monitor paging messages in the newly added paging search spaces. By adding new paging search spaces in the original PO, it can not only reduce the occupation of resources by the paging search spaces, but also reduce the number of parameters for configuring the newly added paging search spaces.

In this example, the present disclosure is described in detail by taking the first paging search spaces as newly added paging search spaces as an example. By adding the paging search spaces, it is possible to monitor paging in the newly added paging search spaces for terminal equipment supporting paging optimization, and only monitor paging in the original paging search spaces for terminal equipment not supporting paging optimization. By adopting this method, on the one hand, the flexibility of network device in transmitting paging messages can be improved, and the power consumption of network device can be reduced.

In some implementations, the newly added paging search spaces are time-divided, i.e., the plurality of paging search spaces do not overlap in the time dimension. It should be noted that the solution of the embodiments of the present disclosure is not limited to time division, that is, the newly added paging search spaces may be time division or frequency division. That is to say, the plurality of newly added paging search spaces may be in the same time domain and different frequency points, or may be in the same frequency point and different time domains. As long as the network device notifies the terminal device of the time-frequency position where the newly added paging search spaces are located through the system message, it can be sufficient.

In some implementations, the newly added paging search spaces and the original paging search spaces are time-divided, that is, the newly added paging search spaces and the original paging search spaces do not overlap in the time dimension. It should be noted that the solution of the embodiments of the present disclosure is not limited to time division, that is, the newly added paging search spaces and the original paging search spaces may be time division or frequency division. That is to say, the newly added paging search spaces and the original paging search spaces can be in the same time domain and different frequency points, or can be in the same frequency point and different time domains. As long as the network device notifies the terminal device of the time-frequency position where the newly added paging search spaces are located through the system message, it can be sufficient.

The above only takes the first PO as an example to introduce the setting method of the newly added paging search spaces. It can be understood that the newly added paging search spaces may be dispersed within each PF and PO for different terminal devices to receive paging messages. The newly added paging search spaces in other POs is similar to the method described above, and will not be described here for the sake of brevity.

### Example 2

In Example 1, the present disclosure is described in detail by taking the first paging search spaces as newly added paging search spaces as an example. In Example 2, however, the first paging search spaces may multiplex the original paging search spaces. Here, multiplexing can be understood as the first paging search spaces being part of the original paging search spaces. For example, the first paging search spaces may include the paging search spaces within one or more original POs. By reusing the original paging search spaces, resources required for paging can be reduced, avoiding resource waste.

In some implementations, the first paging search spaces may include paging search spaces within a plurality of POs. Taking the plurality of POs including a second PO and a third PO as an example, the first paging search spaces may include the paging search spaces within the second PO and the paging search spaces within the third PO.

The embodiments of the disclosure do not specifically limit the number of multiple POs. The number of multiple POs may be 2, 3, 4, etc. It can be understood that the more paging search spaces are multiplexed, the fewer resources are occupied by the first paging search spaces.

The embodiments of the present disclosure do not specifically limit the determination method for a plurality of POs. As an example, the plurality of POs may be indicated to the first terminal device by a network device. As another example, the plurality of POs may be predefined by a protocol. As yet another example, the plurality of POs may be determined by the first terminal device according to a first parameter. For example, one PO among the plurality of POs (referred to as a target PO) may be determined by the first terminal device according to the identifier of the first terminal device (such as S-TMSI), and other POs among the plurality of POs may be determined by the terminal device according to the first parameter and the target PO. The number of other POs may be one or a plurality of. Taking the plurality of POs including a second PO and a third PO as an example, the second PO may be determined based on the identifier of the first terminal device, and the third PO may be determined based on the second PO and the first parameter.

In some embodiments, the first parameter may indicate the interval between other POs and the target PO. The first parameter may include one value or a plurality of values. If the first parameter includes one value, it indicates that there is one other PO; if the first parameter includes a plurality of values, it indicates that there are a plurality of other POs.

Taking the first parameter including parameter K as an example, other POs can be POs that are at a distance of K from the target PO. If the value of K is 1, then the other PO is the next PO after the target PO. If the value of K is 2, then the other PO is the PO after the next PO following the target PO. If the target PO is the last PO within the PF, counting can start from the first PO of the PF. For example, if the target PO is the last PO within the PF and K is 1, then the other PO is the first PO within the PF.

In some embodiments, the first parameter may be an array. For example, if the first parameter is {K1, K2, K3 . . . . Kn}, then starting from the target PO, the K1-th PO, the K2-th PO, the K3-th PO, until the Kn-th PO may all be defined as other POs. Similarly, if the first parameter is defined as {M1, M2, M3 . . . . Mn}, then starting from the target PO, the M1-th PO is the first other PO, the M2-th PO is the second other PO, the M3-th PO is the third other PO, until the Mn-th PO may all be defined as other POs. Where n is an integer greater than or equal to 1.

The first parameter may be indicated to the first terminal device by a network device, or the first parameter may be predefined by a protocol. For example, the first parameter may be sent to the first terminal device by a network device through a system message.

As mentioned above, the first paging search spaces may include a portion of paging search spaces within a plurality of POs. The portion of paging search spaces may be indicated to the first terminal device by the network device, or the portion of paging search spaces may be agreed upon between the first terminal device and the network device, or the portion of paging search spaces may be predefined by the protocol.

Still taking a plurality of POs including a second PO and a third PO as an example, to further save power consumption of the network device, the first paging search spaces can include a portion of the paging search spaces within the second PO and a portion of the paging search spaces within the third PO.

In some embodiments, the SSBs corresponding to a portion of the paging search spaces within the second PO may be different from the SSBs corresponding to a portion of the paging search spaces within the third PO. In this way, it can be ensured that the same SSB is sent only within one PO, thereby avoiding a plurality of transmissions of the same SSB in different POs to reduce power consumption of the network device. As shown in FIG. 8, the first paging search spaces may include the paging search spaces corresponding to SSB0 and SSB2 within the target PO, and the paging search spaces corresponding to SSB1 and SSB3 within other POs. Of course, in some embodiments, the first paging search spaces may include the paging search spaces corresponding to SSB0 and SSB1 within the target PO, and the paging search spaces corresponding to SSB2 and SSB3 within other POs, which is not specifically limited in the embodiments of this disclosure.

In some embodiments, the SSBs corresponding to a portion of the paging search spaces within the second PO and third PO may include all SSBs, thereby ensuring that terminal devices located anywhere within the cell can receive paging messages.

For example, as shown in FIG. 8, assume that a PO contains four paging search spaces, i.e., S=4, corresponding to SSB0 to SSB3 respectively. If the first parameter is 1, then the plurality of POs include one second PO and one third PO, where the third PO is the next PO after the second PO. The terminal device monitors the paging search spaces corresponding to SSB0 and SSB2 within the second PO, and monitors the paging search spaces corresponding to SSB1 and SSB3 within the third PO.

In some embodiments, the number of paging search spaces included in the second PO may be equal to or different from the number of paging search spaces included in the third PO. The following examples are provided using a PO that includes four paging search spaces as an example. For example, the first paging search spaces may include two paging search spaces within the second PO and two paging search spaces within the third PO. Alternatively, the first paging search spaces may include one paging search space within the second PO and three paging search spaces within the third PO. Alternatively, the first paging search spaces may include three paging search spaces within the second PO and one paging search space within the third PO.

This example provides a detailed description of the present disclosure, taking the first paging search spaces as paging search spaces within a plurality of POs. By distributing the paging of terminal device across a plurality of POs, not only can the flexibility of network device in transmitting paging messages be improved, but also the power consumption of network device can be reduced.

In some embodiments, the first paging message may carry only the paging message for the first terminal device. Wherein, the first terminal device is a terminal device that supports paging optimization, that is, the first paging message only transmits paging for terminal devices that support paging optimization, and does not transmit paging for terminal devices that do not support paging optimization. For example, there are two terminal devices A and B being paged, where terminal device A does not support paging optimization and terminal device B supports paging optimization. The network device transmits only the paging for terminal device B in the first paging message, and does not transmit the paging for terminal device A. Correspondingly, for terminal device B that supports paging optimization, it only needs to monitor the first paging message. In some embodiments, the network device may transmit the paging message for terminal device A in the original paging search spaces.

In some embodiments, the first paging message may also carry a paging message for a second terminal device, that is, the first paging message may include a paging message for the first terminal device and also a paging message for the second terminal device, which means that the first paging message may include paging messages for a plurality of terminal devices. Wherein, the second terminal device may be a terminal device that supports paging optimization or a terminal device that does not support paging optimization. If the second terminal device is a terminal device that does not support paging optimization, the terminal device that supports paging optimization and the terminal device that does not support paging optimization may be simultaneously sent in the first paging message. By adopting this method, on one hand, terminal devices that support paging optimization can receive paging messages from a plurality of POs corresponding to SSBs, and by combining the received paging messages, the success rate of terminal devices receiving paging messages can be improved; on the other hand, the implementation by network devices is also relatively simple.

For example, there are two terminal devices, A and B, where terminal device A does not support paging optimization while terminal device B does. The first paging message can include the paging message for terminal device A and the paging message for terminal device B. Accordingly, both the terminal device B that supports paging optimization and the terminal device A that does not support paging optimization may monitor to the first paging message.

When the first paging message carries paging messages for a plurality of terminal devices, the network device can determine different first paging search spaces based on the types of the plurality of terminal devices.

In some embodiments, the network device may determine the first paging search spaces according to the solution described in Example 1 or Example 2 above, and then transmit paging messages for terminal devices supporting paging optimization through the first paging search spaces, while sending paging messages for terminal devices not supporting paging optimization using the original paging search spaces, thereby improving the flexibility of the network device in transmitting paging messages.

As mentioned above, the first paging message may carry paging messages for the first terminal device and the second terminal device, where the second terminal device may be a terminal device that supports paging optimization or does not support paging optimization. Correspondingly, the network device may determine the first paging search spaces based on the capability of the second terminal device.

For example, if the second terminal device is a terminal device that supports paging optimization, the first paging message may be carried only in the newly added paging search spaces within the first PO, or may be carried in both the newly added paging search spaces and the second paging search spaces within the first PO. Here, the newly added paging search spaces within the first PO is the first paging search spaces, and the second paging search spaces are the other paging search spaces within the first PO. That is to say, if the second terminal device is a terminal device that supports paging optimization, the first paging message may be sent only in the newly added paging search spaces, or may be sent in all paging search spaces within the PO.

If the network device transmits the first paging message only in the first paging search spaces, the terminal device can monitor the paging message only in the first paging search spaces. If the network device transmits the first paging message in both the first paging search spaces and the second paging search spaces, the first terminal device can monitor the paging message only in the first paging search spaces to reduce power consumption of the terminal device. Alternatively, the first terminal device can monitor the paging message in both the first paging search spaces and the second paging search spaces, thereby improving the success rate of receiving the paging message by combining the monitored paging messages. Alternatively, the first terminal device can independently choose whether to monitor the paging message in the first paging search spaces or in the second paging search spaces, thereby improving the flexibility of the first terminal device in monitoring paging messages.

For example, as shown in FIG. 6, terminal device B and terminal device C are terminal devices that support paging optimization. In Solution 0, the network device can send the first paging message in the paging search spaces corresponding to the newly added SSB0-SSB3, and also transmit the first paging message in the paging search spaces corresponding to the original SSB0-SSB3. Correspondingly, terminal device B and terminal device C can monitor paging messages only in the paging search spaces corresponding to the newly added SSB0-SSB3, or only in the paging search spaces corresponding to the original SSB0-SSB3. In Solution 1, the network device transmits the first paging message only in the paging search spaces corresponding to the newly added SSB0-SSB3. The first paging message contains the paging messages for terminal device B and terminal device C. Correspondingly, terminal device B and terminal device C can monitor paging messages only in the paging search spaces corresponding to the newly added SSB0-SSB3.

If the second terminal device is a device that does not support paging optimization, then the first paging message is carried in the newly added paging search spaces within the first PO and in the second paging search spaces. Where, the second paging search spaces are another paging search spaces within the first PO. That is to say, if the second terminal device is a device that does not support paging optimization, the first paging message can be sent in all paging search spaces within the entire PO, but cannot be sent only in the newly added paging search spaces, thereby ensuring that any type of terminal device can receive the paging message.

If a network device transmits a first paging message in both the first paging search spaces and the second paging search spaces, then the first terminal device may monitor for paging messages only in the first paging search spaces, and the second terminal device may monitor for paging messages only in the second paging search spaces, thereby reducing the power consumption of the terminal devices.

For example, as shown in FIG. 6, terminal device A is a terminal device that does not support paging optimization, while terminal device B is a terminal device that supports paging optimization. In solution 6, the network device can transmit the first paging message in the paging search spaces corresponding to the newly added SSB0-SSB3, and also transmit the first paging message in the paging search spaces corresponding to the original SSB0-SSB3. For terminal device B, it can monitor paging messages only in the paging search spaces corresponding to the original SSB0-SSB3, or only in the paging search spaces corresponding to the newly added SSB0-SSB3. For terminal device A, it can monitor paging messages only in the paging search spaces corresponding to the original SSB0-SSB3.

In some embodiments, if the first terminal device supports paging optimization and the second terminal device does not support paging optimization, the network device may transmit the paging message for the first terminal device only in the first paging search spaces, and transmit paging messages for both the first terminal device and the second terminal device in the second paging search spaces. Correspondingly, the first terminal device may monitor for paging messages only in the first paging search spaces, and the second terminal device may monitor for paging messages only in the second paging search spaces.

For example, as shown in FIG. 6, terminal device A is a terminal device that does not support paging optimization, while terminal device B is a terminal device that supports paging optimization. In solution 4, the network device can transmit the paging message for terminal device B in the paging search spaces corresponding to the newly added SSB0-SSB3, and transmit paging messages for both terminal device A and terminal device B in the paging search spaces corresponding to the original SSB0-SSB3. For terminal device B, it can monitor paging messages only in the paging search spaces corresponding to the original SSB0-SSB3, and for terminal device A, it can monitor paging messages only in the paging search spaces corresponding to the original SSB0-SSB3.

In some embodiments, if the first terminal device supports paging optimization and the second terminal device does not support paging optimization, the network device may transmit paging messages for both the first terminal device and the second terminal device in the first paging search spaces, and transmit paging messages only for the second terminal device in the second paging search spaces. Correspondingly, the first terminal device may monitor for paging messages only in the first paging search spaces, and the second terminal device may monitor for paging messages only in the second paging search spaces.

For example, as shown in FIG. 6, terminal device A is a terminal device that does not support paging optimization, while terminal device B is a terminal device that supports paging optimization. In solution 5, the network device can transmit paging messages for both terminal device A and terminal device B in the paging search spaces corresponding to the newly added SSB0-SSB3, and transmit paging messages for terminal device A in the paging search spaces corresponding to the original SSB0-SSB3. For terminal device B, it can only monitor for paging messages in the paging search spaces corresponding to the newly added SSB0-SSB3, while for terminal device A, it can only monitor for paging messages in the paging search spaces corresponding to the original SSB0-SSB3.

In some embodiments, if the first terminal device supports paging optimization and the second terminal device does not support paging optimization, the network device may transmit paging messages for the first terminal device and the second terminal device only in the second paging search spaces. Correspondingly, the first terminal device may monitor for paging messages only in the second paging search spaces, and the second terminal device may monitor for paging messages only in the second paging search spaces.

For example, as shown in FIG. 6, terminal device A is a terminal device that does not support paging optimization, while terminal device B is a terminal device that supports paging optimization. In solution 3, the network device can transmit paging messages for both terminal device A and terminal device B in the paging search spaces corresponding to the original SSB0-SSB3. For terminal device B, it can monitor paging messages in both the paging search spaces corresponding to the original SSB0-SSB3 and the paging search spaces corresponding to the newly added SSB0-SSB3. For terminal device A, it can only monitor paging messages in the paging search spaces corresponding to the original SSB0-SSB3.

In some implementations, the first paging search spaces may also be used to transmit a second paging message for a third terminal device, which may include terminal devices that support paging optimization and terminal devices that do not support paging optimization. The embodiments of the present disclosure do not impose specific limitations on the transmission method of the second paging message.

As an example, the second paging message and the first paging message may be carried in the same DCI and the same transport block (TB). As another example, the second paging message and the first paging message may be carried in different pieces of DCIs and/or different TBs. As yet another example, the second paging message and the first paging message may be carried in the same DCI and/or different TBs. In some embodiments, if the type of the first terminal device and the type of the third terminal device are different, the second paging message and the first paging message may be carried in different pieces of DCIs and/or different TBs. For example, when a network device pages terminal device A and terminal device B, it may transmit the paging messages for terminal device A and terminal device B respectively through two pieces o DCIs and/or two TBs within the same paging search spaces. By carrying the second paging message and the first paging message in different pieces of DCIs and/or different TBs, on one hand, the flexibility of the network device in transmitting paging messages can be improved, and on the other hand, the implementation is relatively simple.

For example, as shown in FIG. 6, the network device pages terminal device A and terminal device B within a PO, where terminal device B supports paging optimization while terminal device A does not. In solution 3, solution 4, and solution 6, the network device simultaneously transmits paging messages for terminal device A and terminal device B in the original paging search spaces. The network device can transmit paging messages for terminal device A and terminal device B respectively through two pieces of DCIs and 2 TBs in the same paging search spaces. That is to say, the network device can transmit two paging messages in one paging search space, respectively for paging terminal device A and terminal device B.

In some embodiments, a network device may transmit paging messages for terminal device A and terminal device B in the same paging search spaces through the same DCI and different TBs, that is, invoking two TBs in one DCI, with one TB used for transmitting the second paging message and the other TB used for transmitting the first paging message. Wherein, the second paging message is used for paging terminal device A, and the first paging message is used for paging terminal device B.

Of course, in other embodiments, the network device may transmit paging messages for terminal device A and terminal device B through the same DCI and TB within the same paging search spaces, that is, one paging message contains the paging messages for both terminal device A and terminal device B.

In some implementations, the first paging search spaces are paging search spaces corresponding to portion of the SSBs that the network device is capable of sending, thereby reducing the power consumption of the network device. In some embodiments, the partial SSBs are determined based on the location of the first terminal device. If the network device has a general understanding of the geographical location of the terminal device, it can send paging messages only in the paging search spaces corresponding to parts of the SSBs. In some embodiments, the network device may prioritize sending paging in the paging search spaces corresponding to parts of the SSBs, and then send paging in the search space corresponding to all SSBs.

For example, taking solution 0 and solution 1 in FIG. 6 as an example, if the network device knows that the terminal device B and the terminal device C are within the coverage range of the SSB1, the network device may send a paging message only in the paging search spaces corresponding to the SSB1, thereby reducing power consumption of the network device. In some embodiments, the network device may also first send paging messages in the paging search spaces corresponding to SSB1, and then send paging messages in the paging search spaces corresponding to other SSBs, or the network device may first send paging messages in the paging search spaces corresponding to SSB1, and then send paging messages in the paging search spaces corresponding to all SSBs. As another example, if the network device knows that terminal device B is within the coverage of SSB1 and terminal device C is within the coverage of SSB3, the network device can send paging messages only in the paging search spaces corresponding to SSB1 and SSB3. The above operations are transparent to the terminal device.

In the embodiments of this disclosure, the terminal device may be a terminal device that supports multi-antenna reception. There are two implementation methods for multi-antenna reception: digital multi-antenna reception and analog multi-antenna reception. The terminal device may support one of these methods, and which specific method is supported depends on the capabilities of the terminal device. If the terminal supports digital multi-antenna reception, the terminal can receive a plurality of beams at the same time. If the terminal only supports analog multi-antenna reception, the terminal can only receive beams in one direction at the same time.

In some embodiments, if the first terminal device has digital multi-antenna reception capability, the network device may transmit the first paging message on a plurality of beams of one paging search space of the first paging space, thereby enabling the network device to transmit the first paging message on only some paging search spaces to reduce power consumption of the network device. For example, assuming that the first paging search spaces include paging search space 0 to paging search space 3, and the beams corresponding to the network device include beam 0 to beam 3, the network device may send beam 0 and beam 1 in paging search space 0, and send beam 2 and beam 3 in paging search space, thereby completing transmission of all beams through two paging search spaces. Here, the first paging message is carried on each beam.

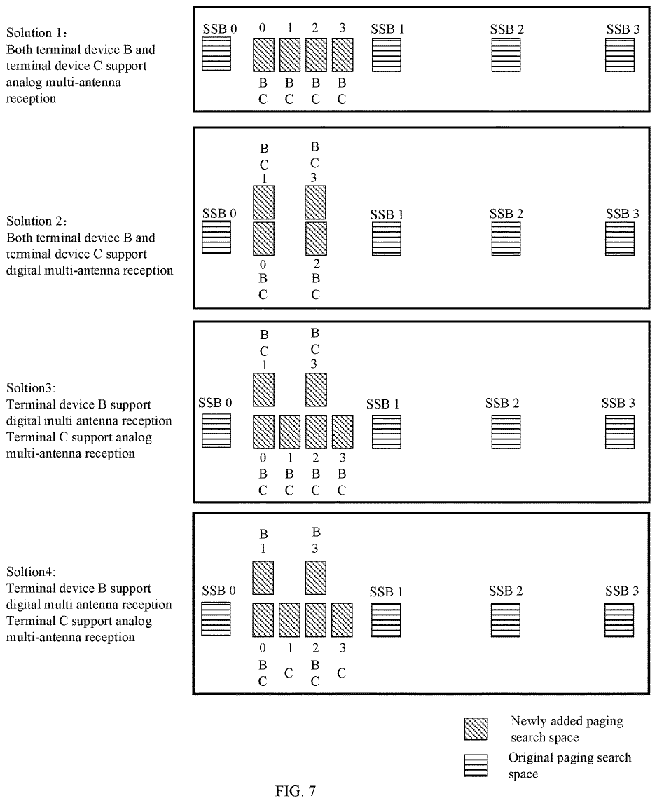

In some embodiments, the first paging message may carry paging messages for a plurality of terminal devices. The network device can determine the transmission method of the first paging message based on the multi-antenna reception capabilities of the plurality of terminal devices. This is illustrated below with reference to FIG. 7. In the solution shown in FIG. 7, the network device pages terminal device B and terminal device C within a PO, and both terminal device B and terminal device C support paging optimization.

If terminal device B and terminal device C both support simulated multi-antenna reception, the network device can only send paging within the PO corresponding to all SSBs, as shown in solution 1 in FIG. 7. The network device can transmit paging messages in all four newly added paging search spaces, with each paging search spaces sending one beam, and each beam used to carry the paging messages for terminal device B and terminal device C.

If terminal device B and terminal device C both support digital multi-antenna reception, the network device can send paging messages to the terminal devices through a plurality of beams at the same time, and the network device can transmit paging messages in only some paging search spaces. As shown in solution 2 in FIG. 7, the network device can send paging messages in only two paging search spaces, where one paging search space is used to send beam 1 and beam 1, and other paging search spaces are used to send beam 2 and beam 3. Wherein, each beam is used to carry the paging messages for terminal device B and terminal device C.

If terminal device B supports digital multi-antenna reception and terminal device C supports analog multi-antenna reception, the network device can send paging messages through a plurality of beams in some paging search spaces, with each beam corresponding to a different SSB. As shown in solution 3 in FIG. 7, the network device can send a plurality of beams in the first and third paging search spaces, while sending a single beam in the second and fourth paging search spaces. Among them, the first paging search spaces are used to send beam 0 and beam 1, and the third paging search spaces are used to send beam 2 and beam 3. Each beam is used to carry paging messages for terminal device B and terminal device C. As shown in solution 4 in FIG. 7, the network device can send a plurality of beams in the first and third paging search spaces, while sending a single beam in the second and fourth paging search spaces. Among them, the first paging search spaces are used to send beam 0 and beam 1, the third paging search spaces are used to send beam 2 and beam 3, and the first and third paging search spaces are used to send paging messages for terminal device B and terminal device C. The second and fourth paging search spaces are only used to send paging messages for terminal device C.

Taking a network device as a base station as an example, the solution of the embodiments of the present disclosure is elaborated in detail with two more specific examples.

### Example 1

Example 1 describes a solution where the first paging search spaces are newly added paging search spaces.

Continuing to refer to FIG. 6, the base station adds new POs to the existing POs for paging optimization, as additional paging search spaces, and designates the additional paging search spaces as the first paging search spaces for transmitting the first paging message. Here, the newly added POs and the original POs are time-divisional, meaning that a plurality of paging search spaces do not overlap in the time dimension. It should be noted that the solution of the embodiments of the present disclosure is not limited to time division, that is, the newly added paging search spaces may be time division or frequency division.

In FIG. 6, it is assumed that the current cell has four SSBs, i.e., S=4, and this paging optimization adds four new paging search spaces, corresponding to SSB0 to SSB3 respectively. The newly added paging search spaces are indicated to the terminal device by the base station, for example, the base station can indicate the newly added paging search spaces to the terminal device through system messages. Only terminal devices that support paging optimization can read parameters related to the newly added paging search spaces, thereby being aware of the 4 newly added paging search spaces. Terminal devices that do not support paging optimization cannot perceive the existence of the four newly added paging search spaces.

Solution 0 and solution 1 in FIG. 6 correspond to a scenario where all terminal devices paged within the current PO support paging optimization. For example, the base station pages terminal device B and terminal device C within the PO, and both terminal device B and terminal device C are terminal devices that support paging optimization.

In Solution 0, the base station transmits the first paging message in the paging search spaces corresponding to both the newly added SSB0-SSB3 and the original SSB0-SSB3. Correspondingly, terminal device B and terminal device C can monitor for paging messages only in the paging search spaces corresponding to the newly added SSB0-SSB3, or only in the paging search spaces corresponding to the original SSB0-SSB3. The terminal device behavior is relatively flexible, but the base station power consumption is relatively high.

In Solution 1, the base station transmits the first paging message only in the paging search spaces corresponding to the newly added SSB0-SSB3, and does not transmit the first paging message in the paging search spaces corresponding to the original SSB0-SSB3. Wherein, the first paging message contains the paging messages for terminal device B and terminal device C. Correspondingly, terminal device B and terminal device C monitor paging messages only in the paging search spaces corresponding to the newly added SSB0-SSB3. Compared with Solution 0, Solution 1 has lower base station power consumption.

Solutions 2 to 6 in FIG. 6 correspond to scenarios where only some of the plurality of terminal devices paged within the PO support paging optimization. For example, the base station pages the terminal device A and the terminal device B in the PO, where the terminal device A is a terminal device that does not support paging optimization, and the terminal device B is a terminal device that supports paging optimization.

In Solution 2, the base station transmits the paging message for terminal device A in the paging search spaces corresponding to the original SSB0-SSB3, and transmits the paging message for terminal device B in the paging search spaces corresponding to the newly added SSB0-SSB3. For terminal device B, it can monitor the paging message only in the paging search spaces corresponding to the newly added SSB0-SSB3, while for terminal device A, it can monitor the paging message only in the paging search spaces corresponding to the original SSB0-SSB3.

In Solution 3, the base station transmits paging messages for terminal device A and terminal device B in the paging search spaces corresponding to the original SSB0-SSB3. For terminal device B, it can monitor paging messages in both the paging search spaces corresponding to the original SSB0-SSB3 and the paging search spaces corresponding to the newly added SSB0-SSB3. For terminal device A, it can monitor paging messages only in the paging search spaces corresponding to the original SSB0-SSB3. Therefore, compared with Solution 2, in Solution 3, the power consumption of terminal devices increases, while the power consumption of the base station decreases.

In Solution 4, the base station transmits the paging message for terminal device B in the paging search spaces corresponding to the newly added SSB0-SSB3, and transmits the paging messages for both terminal device A and terminal device B in the paging search spaces corresponding to the original SSB0-SSB3. For terminal device B, it can monitor paging messages only in the paging search spaces corresponding to the original SSB0-SSB3, or only in the paging search spaces corresponding to the newly added SSB0-SSB3. Specifically, which paging search spaces to monitor for paging messages can be determined by terminal device B itself. For terminal device A, it can monitor paging messages only in the paging search spaces corresponding to the original SSB0-SSB3. The terminal device behavior is relatively flexible, and the base station power consumption is comparable to that of Solution 2.

In Solution 5, the base station transmits paging messages for terminal device A and terminal device B in the paging search spaces corresponding to the newly added SSB0-SSB3, and transmits paging messages for terminal device A in the paging search spaces corresponding to the original SSB0-SSB3. For terminal device B, it can monitor the paging message only in the paging search spaces corresponding to the newly added SSB0-SSB3, while for terminal device A, it can monitor the paging message only in the paging search spaces corresponding to the original SSB0-SSB3. The terminal devices consume less power, but the base station consumes more power.

In Solution 6, the base station transmits the first paging message in the paging search spaces corresponding to both the newly added SSB0-SSB3 and the original SSB0-SSB3. For terminal device B, it can monitor paging messages only in the paging search spaces corresponding to the original SSB0-SSB3, or only in the paging search spaces corresponding to the newly added SSB0-SSB3. Specifically, which paging search spaces to monitor for paging messages can be determined by terminal device B itself. For terminal device A, it can monitor paging messages only in the paging search spaces corresponding to the original SSB0-SSB3. The terminal device behavior is relatively flexible, but the base station power consumption is relatively high.

By comparison, if both Solution 1 and Solution 3 are adopted simultaneously, the base station power consumption is the lowest. However, since terminal devices cannot perceive whether other terminal devices within the PO support paging optimization, they need to monitor paging messages in both the original paging search spaces corresponding to SSB0-SSB3 and the newly added paging search spaces corresponding to SSB0-SSB3, which results in relatively higher power consumption for terminal devices that support paging optimization.

If both Solution 1 and Solution 2 are adopted, the power consumption of the base station is lower, and the power consumption of terminal devices supporting paging optimization is also lower, making it the optimal choice.

The embodiments of this disclosure do not specifically limit which paging scheme is adopted. In some implementations, the protocol may specify one of the paging schemes. In some implementations, the protocol may specify one of the paging schemes. In other implementations, the protocol may specify a plurality of schemes, and the base station may select one of them as the final scheme and notify the terminal device through system messages. Terminal devices supporting paging optimization can determine in which paging search spaces to monitor paging according to the system message indications.

In this example, the present disclosure is described in detail by taking the first paging search spaces as newly added paging search spaces as an example. By adding the paging search spaces, it is possible to monitor paging in the newly added paging search spaces for terminal equipment supporting paging optimization, and only monitor paging in the original paging search spaces for terminal equipment not supporting paging optimization. By adopting this method, on the one hand, the flexibility of network device in transmitting paging messages can be improved, and the power consumption of network device can be reduced.

On the other hand, as the network continues to evolve, more and more terminal devices support paging optimization while fewer and fewer terminal devices do not support paging optimization. Consequently, the paging that base stations send through the original paging search spaces becomes less frequent. If a particular paging search spaces has no corresponding terminal devices, the base station may choose not to send paging messages, thereby concentrating paging in the newly added paging search spaces. Since the time intervals between the newly added paging search spaces are relatively small, they can share a single measurement reference signal. Therefore, the network device only needs to send one measurement reference signal to the terminal device, and the terminal device only needs to measure the reference signal once, which can reduce power consumption for both network devices and terminal devices.

### Example 2

Example 2 describes a solution where the first paging search spaces multiplexing the original paging search spaces. Wherein, the first paging search spaces are paging search spaces within a plurality of POs, which include a second PO and a third PO. For ease of description, in this example, the second PO is referred to as the target PO, and the third PO is referred to as the other PO.

Referring to FIG. 8, there are a plurality of POs in the current PF, with one PO containing four paging search spaces, i.e., S=4, corresponding to SSB0 to SSB3 respectively. The terminal device calculates the target PO. Assuming the first parameter is 1, the plurality of POs include one target PO and one other PO, where the other PO is the next PO following the target PO.

The embodiments of this disclosure do not specifically limit the paging search spaces monitored by the target PO and other POs, as long as it is ensured that the terminal device monitors the paging search spaces corresponding to all SSBs, and the SSBs corresponding to the paging search spaces within the target PO and other POs are different.

As shown in FIG. 8, the first paging search spaces may include the paging search spaces corresponding to SSB0 and SSB2 within the target PO, and the paging search spaces corresponding to SSB1 and SSB3 within other POs. Of course, in some embodiments, the first paging search spaces may include the paging search spaces corresponding to SSB0 and SSB1 within the target PO, and the paging search spaces corresponding to SSB2 and SSB3 within other POs.

This example provides a detailed description of the present disclosure, taking the first paging search spaces as paging search spaces within a plurality of POs. By distributing the paging of terminal device across a plurality of POs, not only can the flexibility of network device in transmitting paging messages be improved, but also the power consumption of network device can be reduced.

On the other hand, as the network continues to evolve, more terminal devices support paging optimization while fewer terminal devices do not. Consequently, fewer paging messages are transmitted in the paging search spaces originally used for terminal devices that do not support paging optimization. If no terminal devices correspond to a particular paging search spaces, the base station can choose not to send paging messages, thereby concentrating paging in a portion of the paging search spaces and reducing base station power consumption.

In some implementations, before the first terminal device receives a first paging message sent by a network device, the first terminal device may send first capability information to the network device. The first capability information is used to indicate whether the first terminal device supports paging optimization, or in other words, the first capability information is used to indicate whether the first terminal device has the capability of paging optimization. Of course, after the first terminal device sends the first capability information to the network device, whether the network device adopts paging optimization to send paging messages belongs to the implementation of the network device. That is to say, after the first terminal device sends the first capability information to the network device, the network device may adopt paging optimization to send paging messages, or may not adopt paging optimization to send paging messages.

The embodiments of this disclosure do not specifically limit the carrying method of the first capability information. As an example, the first capability information may be carried in a Radio Resource Control (RRC) message, that is, the first terminal device may report the first capability information through an RRC message. As another example, the first capability information may be carried in a Medium Access Control Control Element (MAC CE), that is, the first terminal device may report the first capability information through a MAC CE.

In some embodiments, if the first capability information is carried by an RRC message, the RRC message may be a UE capability reporting message and/or a UE assistance information reporting message (or referred to as a UE assistance message).

In some embodiments, if the RRC message is a UE capability reporting message, the first capability information is also used for storage in the AMF. For example, the network device may send the first capability information to the AMF, so that the AMF stores the first capability information in the AMF. By storing the first capability information in the AMF, when the first terminal device accesses the network next time, the network device can directly obtain the first capability information from the AMF, without requiring the first terminal device to report the first capability information again, thereby reducing air interface signaling overhead. When the AMF receives “data arrival for the first terminal device,” the AMF can query the capabilities of the first terminal device stored in itself to determine whether the first terminal device supports paging optimization. The AMF may notify the network device of the capability of the first terminal device through a paging request message.

In some embodiments, if the RRC message is a UE assistance information reporting message, the AMF does not store the first capability information, therefore, when the first terminal device accesses next time, it needs to report the first capability information again.

In some implementations, before the first terminal device receives the first paging message sent by the network device, the first terminal device may also obtain first information. The first information is used to indicate whether the cell on which the first terminal device resides implements paging optimization.

The embodiments of present disclosure do not specifically limit the carrying method of the first information. As an example, the first information may be carried in system information (or system message), that is, the first terminal device may acquire the first information through system information. As another example, the first information may be carried in a system information block (SIB). The SIB may be SIB1, or the SIB may be other SIBs such as SIB2, SIB3, etc.

In some embodiments, the first information may indicate whether the cell where the first terminal device resides implements paging optimization through explicit or implicit means. For example, the first information may indicate whether the cell where the first terminal device resides implements paging optimization through one or more of the following ways: the value of a first variable; whether a second parameter exists. The cell where the terminal device resides may also be referred to as the current cell. The above situations are illustrated below with examples.

In some embodiments, the first information may indicate whether a cell on which the first terminal device resides implements paging optimization through the value of the first variable, and this indication method may be understood as an explicit indication method. In some embodiments, the first variable may be a Boolean variable or an enumerated variable.

The embodiments of the present disclosure do not specifically limit the number of bits occupied by the first variable. For example, the number of bits occupied by the first variable may be one or may be multiple.

If the first variable is a Boolean variable, when the first variable takes the first value, it indicates that the cell where the first terminal device resides implements paging optimization; when the first variable takes the second value, it indicates that the cell where the first terminal device resides does not implement paging optimization. Taking the first variable occupying one bit as an example, when the value of the first variable is 1, it indicates that the cell where the first terminal device resides implements paging optimization; when the value of the first variable is 0, it indicates that the cell where the first terminal device resides does not implement paging optimization. Alternatively, when the value of the first variable is 0, it indicates that the cell where the first terminal device resides implements paging optimization; when the value of the first variable is 1, it indicates that the cell where the first terminal device resides does not implement paging optimization.

If the first variable is an enumeration variable, when the second parameter is present, it indicates that the cell where the first terminal device resides implements paging optimization; when the second parameter is absent, it indicates that the cell where the first terminal device resides does not implement paging optimization. Alternatively, when the second parameter is absent, it indicates that the cell where the first terminal device resides implements paging optimization; when the second parameter is present, it indicates that the cell where the first terminal device resides does not implement paging optimization. Here, the second parameter can be the first variable.

In some embodiments, the first information may implicitly indicate through a second parameter whether the cell where the first terminal device resides implements paging optimization. The second parameter may be a newly defined parameter. For example, the second parameter may be a parameter of an additional paging search spaces. For example, on the basis of the data structure of the paging search spaces configuration message mentioned above, some additional parameters may be introduced to define new paging search spaces. The additionally introduced parameter is the second parameter. If the second parameter is present, it indicates that the cell where the first terminal device resides implements paging optimization, and if the second parameter is absent, it indicates that the cell where the first terminal device resides does not implement paging optimization; or, if the second parameter is absent, it indicates that the cell where the first terminal device resides implements paging optimization, and if the second parameter is present, it indicates that the cell where the first terminal device resides does not implement paging optimization.

In other implementations, it may be specified by the protocol whether the cell where the first terminal device resides implements paging optimization. For example, for network devices in R19 and later, if they support the NES feature, the cells corresponding to these network devices will definitely implement paging optimization.

The first terminal device and the network device can determine whether paging transmission is optimized based on the first capability information and the first information. If paging transmission is optimized, the network device sends paging messages in the manner described above, and the first terminal device monitors paging messages in the manner described above; if paging transmission is not optimized, the network device may send paging messages in a conventional manner, and the first terminal device monitors paging messages in a conventional manner.

Depending on the first capability information and the first information, it can be divided into six scenarios, as shown in Table 1.

As shown in Table 1, paging over the air interface is optimized only when the network device supports paging optimization and all or some of the plurality of terminal devices receiving paging in the current PO support paging optimization. As shown in scenarios 1 and 5 in Table 1.

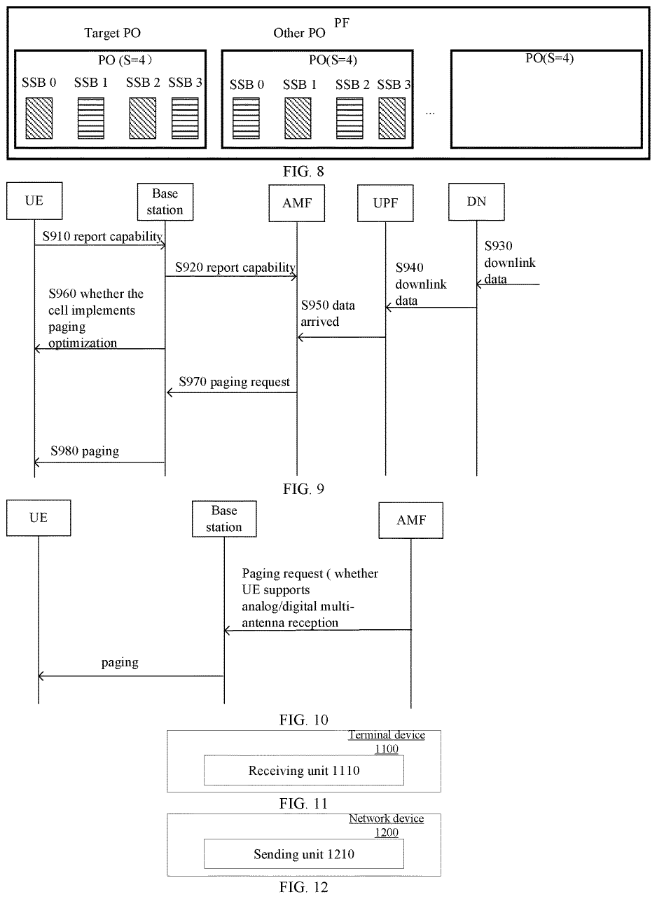

Taking a terminal device as UE and a network device as a base station as an example, the following provides a more detailed illustration of how the base station determines whether to implement paging optimization for the UE in conjunction with FIG. 9.

At S910, the UE reports capabilities to the base station, that is, sends first capability information.

At S920, if the UE reports through the terminal device capability message and the base station reports the UE capability to the AMF, the AMF stores the terminal device capability information.

At S930, the DN receives downlink data.

At S940, the downlink data is sent by the DN to the UPF.

At S950, after the downlink data arrives at the UPF, the UPF finds that there is no downlink data channel for the terminal device, and then notifies the AMF: data has arrived.

At S960, the UE determines whether the serving cell implements paging optimization.

At S970, when the AMF receives a notification that data has arrived, the AMF queries the terminal device capabilities stored in its own memory, determines whether the UE supports paging optimization, and notifies the base station of this message in the form of a paging request.

At S980, after receiving the paging request, the base station determines whether paging optimization is implemented in the cell where the UE is located, and sends a paging to the UE.

TABLE 1
Paging optimization scenario implemented
by the first terminal device

| | Whether a plurality | Whether the | |
|---|---|---|---|
| | of terminal devices | network device | Whether |
| | sending paging in this | implements | paging |
| | PO support paging | paging | transmission is |
| | optimization | optimization | optimized |
| Scenario 1 | All supported | Implement | optimize |
| Scenario 2 | All supported | Not implemented | Not optimized |
| Scenario 3 | None supported | Implement | Not optimized |
| Scenario 4 | None supported | Not implemented | Not optimized |
| Scenario 5 | Some terminal devices | Implement | optimize |
| | support it, while | | |
| | others do not | | |
| Scenario 6 | Some terminal devices | Not implemented | Not optimized |
| | support it, while | | |
| | others do not | | |

In some implementations, when the AMF sends a paging request to a base station, it can notify the UE of its capability to support digital multi-antenna reception or analog multi-antenna reception. The base station can determine the specific paging transmission method based on the capabilities of a plurality of UEs to be paged within the same PO.

As shown in FIG. 10, when the AMF sends a paging request for the UE to the base station, it carries information about whether the UE supports analog/digital multi-antenna reception capability in the paging request. After receiving the paging request, the base station first determines the specific paging transmission method and then sends the paging to the UE.

The method embodiments of the present disclosure have been described in detail above with reference to FIGS. 1 to 10, and the devices embodiments of the present disclosure will be described in detail below with reference to FIGS. 11 to 16. It should be understood that the description of the method embodiment and the description of the device embodiment correspond to each other, and therefore, the portions not described in detail can be referred to the foregoing method embodiments.

FIG. 11 is a schematic diagram of a structure of a terminal device provided in embodiments of the present disclosure. The terminal device 1100 shown in FIG. 11 may include a receiving unit 1110. The receiving unit 1110 may be used to receive a first paging message sent by a network device, where the first paging message is carried in first paging search spaces, and the first paging search spaces are determined based on the capability of the first terminal device and/or whether paging optimization is implemented in the cell where the first terminal device resides.

In some implementations, the first terminal device is a terminal device supporting paging optimization, the first paging search spaces are newly added paging search spaces, or the first paging search spaces are paging search spaces within a plurality of POs.

In some implementations, the first paging search spaces are newly added paging search spaces within a first PO, and the first PO is determined based on the identifier of the terminal device.

In some implementations, the first paging message further includes a paging message for a second terminal device, where the second terminal device is a terminal device that supports paging optimization or does not support paging optimization.

In some implementations, if the second terminal device is a terminal device that supports paging optimization, the first paging message is carried only in newly added paging search spaces in the first PO, or the first paging message is carried in newly added paging search spaces in the first PO and second paging search spaces, and the second paging search spaces are another paging search spaces in the first PO.

In some implementations, if the second terminal device is a terminal device that does not support paging optimization, then the first paging message is carried in newly added paging search spaces within the first PO and second paging search spaces, wherein the second paging search spaces are another paging search spaces within the first PO.

In some implementations, the first paging search spaces are also used to transmit a second paging message for a third terminal device, where the second paging message and the first paging message are carried in different pieces of DCIs and/or different transport blocks.

In some implementations, the first paging search spaces are paging search spaces corresponding to some of the SSBs that the network device can send.

In some implementations, the portion of SSBs are determined based on the location of the first terminal device.

In some implementations, if the first terminal device has digital multi-antenna reception capability, then one paging search space of the first paging search spaces is used for transmitting the first paging message on a plurality of beams.

In some implementations, the plurality of POs include a second PO and a third PO, wherein the second PO is determined based on the identifier of the first terminal device, and the third PO is determined based on the second PO and a first parameter.

In some implementations, the first parameter is sent to the first terminal device through a system message.

In some implementations, the first paging search spaces includes a portion of paging search spaces within the second PO and a portion of paging search spaces within the third PO.

In some implementations, the SSBs corresponding to a portion of the paging search spaces within the second PO is different from the SSBs corresponding to a portion of the paging search spaces within the third PO.

In some implementations, the third PO includes one or more POs.

In some implementations, the terminal device 1100 further comprises: a sending unit, configured to send first capability information to the network device, wherein the first capability information is used to indicate whether the terminal device supports paging optimization.

In some implementations, the first capability information is carried in an RRC message or in a MAC CE.

In some implementations, the RRC message includes a UE capability reporting message and/or a UE assistance information reporting message.

In some implementations, if the RRC message is a UE capability reporting message, the first capability information is further used for storage in an AMF.

In some implementations, the terminal device 1100 further comprises: an acquisition unit, configured to acquire first information, wherein the first information is used to indicate whether a cell on which the first terminal device resides implements paging optimization.

In some implementations, the first information is carried in system information or SIB.

In some implementations, the first information indicates whether a cell in which the first terminal device resides implements paging optimization by one or more of: a value of a first variable; whether the second parameter exists or not.

In some implementations, the terminal device 1100 further comprises: a determining unit, configured to determine the first paging search spaces based on the capability of the first terminal device and the first information.

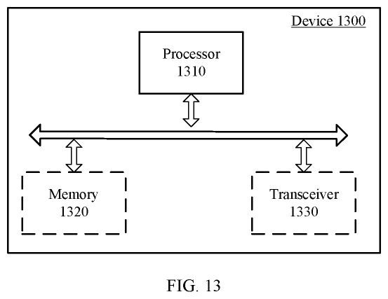

FIG. 12 is a schematic diagram of a structure of a network device provided in some embodiments of the present disclosure. The network device 1200 shown in FIG. 12 may include a sending unit 1210. The sending unit 1210 is configured to send a first paging message to the terminal device, where the first paging message is carried in first paging search spaces, and the first paging search spaces are determined based on a capability of the first terminal device and/or whether a cell in which the first terminal device resides implements paging optimization.

In some implementations, the first terminal device is a terminal device supporting paging optimization, the first paging search spaces are newly added paging search spaces, or the first paging search spaces are paging search spaces within a plurality of POs.

In some implementations, the first paging search spaces are newly added paging search spaces within a first PO, and the first PO is determined based on the identifier of the terminal device.

In some implementations, the first paging message further includes a paging message for a second terminal device, where the second terminal device is a terminal device that supports paging optimization or does not support paging optimization.

In some implementations, if the second terminal device is a terminal device that supports paging optimization, the first paging message is carried only in newly added paging search spaces in the first PO, or the first paging message is carried in newly added paging search spaces in the first PO and second paging search spaces, and the second paging search spaces are other paging search spaces in the first PO.

In some implementations, if the second terminal device is a terminal device that does not support paging optimization, then the first paging message is carried in newly added paging search spaces within the first PO and second paging search spaces, wherein the second paging search spaces are other paging search spaces within the first PO.

In some implementations, the first paging search spaces are also used to transmit a second paging message for a third terminal device, where the second paging message and the first paging message are carried in different pieces of DCIs and/or different transport blocks.

In some implementations, the first paging search spaces are paging search spaces corresponding to some of the SSBs that the network device can send.

In some implementations, the portion of SSBs are determined based on the location of the first terminal device.

In some implementations, if the first terminal device has digital multi-antenna reception capability, then one paging search space of the first paging search spaces is used for transmitting the first paging message on a plurality of beams.

In some implementations, the plurality of POs include a second PO and a third PO, wherein the second PO is determined based on the identifier of the first terminal device, and the third PO is determined based on the second PO and a first parameter.

In some implementations, the first parameter is sent to the first terminal device through a system message.

In some implementations, the first paging search spaces includes a portion of paging search spaces within the second PO and a portion of paging search spaces within the third PO.

In some implementations, the SSBs corresponding to portion of the paging search spaces within the second PO are different from the SSBs corresponding to portion of the paging search spaces within the third PO.

In some implementations, the third PO includes one or more POs.

In some implementations, the network device 1200 further includes: a receiving unit, configured to receive first capability information sent by the terminal device, where the first capability information is used to indicate whether the terminal device supports paging optimization.

In some implementations, the first capability information is carried in an RRC message or in a MAC CE.

In some implementations, the RRC message includes a UE capability reporting message and/or a UE assistance information reporting message.

In some implementations, if the RRC message is a UE capability reporting message, the first capability information is further used for storage in an AMF.

In some implementations, the sending unit is further configured to send first information to the terminal device, and the first information is used to indicate whether a cell in which the first terminal device resides implements paging optimization.

In some implementations, the first information is carried in system information or SIB.

In some implementations, the first information indicates whether a cell in which the first terminal device resides implements paging optimization by one or more of: a value of a first variable; whether the second parameter exists or not.

FIG. 13 is a schematic configuration diagram of a communication device according to an embodiment of the present disclosure. The dashed line in FIG. 13 indicates that the unit or module is optional. The device 1300 may be used to implement the method described in the method embodiments described above. The device 1300 may be a chip, a terminal device, or a network device.

The device 1300 may include one or more processors 1310. The processor 1310 may support the device 1300 to implement the methods described in the above method embodiments. The processor 1310 may be a general-purpose processor or a special-purpose processor. For example, the processor may be a central processing unit (CPU). Alternatively, the processor may also be another general-purpose processor, a digital signal processor (DSP), a disclosure specific integrated circuit (ASIC), an off-the-shelf programmable gate array (FPGA) or other programmable logic device, a discrete gate or transistor logic device, a discrete hardware component, or the like. The general-purpose processor may be a microprocessor or the processor may be any conventional processor or the like.

The device 1300 may also include one or more memories 1320. The memory 1320 has stored a program that can be executed by the processor 1310 to cause the processor 1310 to perform the method described in the above method embodiments. The memory 1320 may be independent of the processor 1310 or may be integrated in the processor 1310.

The device 1300 may also include a transceiver 1330. The processor 1310 may communicate with other devices or chips through the transceiver 1330. For example, the processor 1310 may send and receive data with other devices or chips through the transceiver 1330.

The embodiments of the present disclosure further provide a computer-readable storage medium configured to store programs. The computer-readable storage medium can be applied to a terminal or a network device provided by an embodiment of the present disclosure, and the program causes a computer to execute a method executed by the terminal or the network device in each embodiment of the present disclosure.

The embodiments of the present disclosure further provide a computer program product. The computer program product includes a program. The computer program product is applicable to the terminal devices or the network devices provided in the embodiments of the present disclosure, and the programs cause a computer to perform operations of the method executed by the terminal device or network device in the various embodiments of the present disclosure.

The embodiments of the present disclosure further provide a computer program. The computer program is applicable to the terminal devices or the network devices provided in the embodiments of the present disclosure, and the computer program causes a computer to perform operations of the method executed by the terminal device or network device in the various embodiments of the present disclosure.

It should be understood that the terms “system” and “network” in the present disclosure may be used interchangeably. In addition, the terms used in the present disclosure are only used to explain the embodiments of the present disclosure, and are not intended to limit the present disclosure. The terms “first”, “second”, “third”, “fourth”, and the like in the description, claims, and drawings of the present disclosure are used to distinguish different objects, rather than to describe a specific order. In addition, the terms “comprise” and “have” and any variations thereof are intended to cover a non-exclusive inclusion.

In the embodiments of the present disclosure, “indicate” mentioned herein may refer to a direct indication, or may refer to an indirect indication, or may represent that there is an association relationship. For example, A indicates B, which may represent that A directly indicates B, for example, B may be derived from A; or may represent that A indirectly indicates B, for example, A indicates C, and B may be derived from C; or may represent that there is an association relationship between A and B.

In the embodiments of the present disclosure, “B corresponding to A” represents that B is associated with A, and B may be determined based on A. However, it should also be understood that, determining B based on A does not only represent determining B based only on A, but instead B may be determined based on A and/or other information.

In the embodiments of the present disclosure, the term “corresponding” may represent that there is a direct or indirect correspondence between the two, or may represent that there is an association relationship between the two, or may represent that there is a relationship such as indicating and being indicated, or configuring and being configured.

In the embodiments of the present disclosure, “predefined” or “preconfigured” can be implemented by pre-storing corresponding code, tables, or other means that can be used to indicate relevant information in a device (for example, including terminal equipment and network device), and the disclosure does not limit its specific implementation method. For example, predefined may refer to being defined in a protocol.

In the embodiments of the present disclosure, the “protocol” may refer to a standard protocol in the communications field, and may include, for example, an LTE protocol, an NR protocol, and a related protocol applied to a future communications system, which is not limited in the present disclosure.

In the embodiments of the present disclosure, the term “and/or” is merely used to describe an association relationship between associated objects, indicating that there may be three relationships. For example, A and/or B may indicate that: only A exists, both A and B exist, and only B exists. In addition, the character “/” herein generally indicates an “or” relationship between the associated objects.

In the embodiments of the present disclosure, sequence numbers of the foregoing processes do not represent execution sequences. The execution sequences of the processes should be determined according to functions and internal logics of the processes, and should not be construed as any limitation on the implementation processes of the embodiments of the present disclosure.

In the embodiments provided in the present disclosure, it should be understood that, the disclosed system, apparatus, and method may be implemented in other manners. For example, the described device embodiments are merely exemplary. For example, the division of units is merely logical function division and there may be other division manners in practice. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to an actual need to achieve the objectives of the solutions of the embodiments.

In addition, function units in the embodiments of the present disclosure may be integrated into one processing unit, or each of the units may exist alone physically, or two or more units are integrated into one unit.

All or some of the foregoing embodiments may be implemented by using software, hardware, firmware, or any combination thereof. When software is configured to implement embodiments, the foregoing embodiments may be implemented completely or partially in a form of computer program products. A computer program product includes one or more computer instructions. When the computer program instructions are loaded and executed on a computer, the procedures or functions according to the embodiments of the present disclosure are completely or partially generated. The computer may be a general-purpose computer, a dedicated computer, a computer network, or other programmable apparatuses. The computer instructions may be stored in a computer-readable storage medium or sent from one computer-readable storage medium to another computer-readable storage medium. For example, the computer instructions may be sent from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center formed by integrating one or more usable medium. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of the present disclosure, but the protection scope of the present disclosure is not limited thereto. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method for wireless communication, comprising:
receiving, by a first terminal device, a first paging message from a network device,
wherein the first paging message is carried in first paging search spaces, and the first paging search spaces are determined based on at least one of a capability of the first terminal device or whether a cell in which the first terminal device resides implements paging optimization.

2. The method according to claim 1, wherein the first terminal device is a terminal device supporting paging optimization, and the first paging search spaces are newly added paging search spaces or paging search spaces within a plurality of paging occasions (POs).

3. The method according to claim 2, wherein the first paging search spaces are newly added paging search spaces within a first PO, and the first PO is determined based on an identifier of the first terminal device.

4. The method according to claim 3, wherein the first paging message further comprises a paging message for a second terminal device, wherein the second terminal device is a terminal device that supports paging optimization or a terminal device that does not support paging optimization.

5. The method according to claim 4, wherein in response to the second terminal device being a terminal device supporting paging optimization, the first paging message is carried in newly added paging search spaces within the first PO but not in other paging search spaces within the first PO; or
the first paging message is carried in newly added paging search spaces within the first PO and second paging search spaces, wherein the second paging search spaces are other paging search spaces within the first PO.

6. The method according to claim 4, wherein in response to the second terminal device being a terminal device that does not support paging optimization, the first paging message is carried in newly added paging search spaces within the first PO and second paging search spaces, wherein the second paging search spaces are other paging search spaces within the first PO.

7. The method according to claim 4, wherein the first paging search spaces are further configured for transmitting a second paging message for a third terminal device, wherein the second paging message and the first paging message are carried in different pieces of downlink control information (DCIs) or different transport blocks (TBs).

8. The method according to claim 3, wherein the first paging search spaces are paging search spaces corresponding to a portion of Synchronization Signal Blocks (SSBs) that the network device is capable of sending, and wherein the portion of SSBs are determined based on a position of the first terminal device.

9. The method according to claim 3, wherein the first terminal device has digital multi-antenna reception capability, one paging search space of the first paging search spaces is configured for sending the first paging message over a plurality of beams.

10. The method according to claim 2, wherein the plurality of POs comprise a second PO and a third PO, the second PO is determined based on an identifier of the first terminal device, and the third PO is determined based on the second PO and a first parameter, wherein the third PO comprises one or more POs.

11. The method according to claim 10, wherein the first parameter is sent to the first terminal device using a system message.

12. The method according to claim 10, wherein the first paging search spaces comprises a portion of paging search spaces within the second PO and a portion of paging search spaces within the third PO, wherein the SSBs corresponding to the portion of paging search spaces within the second PO are different from the SSBs corresponding to the portion of paging search spaces within the third PO.

13. The method according to claim 1, further comprising:
sending, by the first terminal device, first capability information to the network device, wherein the first capability information indicates whether the first terminal device supports paging optimization.

14. The method according to claim 13, wherein the first capability information is carried in a Radio Resource Control (RRC) message or a Medium Access Control (MAC) Control Element (CE).

15. The method according to claim 14, wherein the RRC message includes at least one of a user equipment (UE) capability reporting message or a UE assistance information reporting message.

16. The method according to claim 15, wherein the RRC message is the UE capability reporting message, and the first capability information is used to be stored in an Access and Mobility Management Function (AMF).

17. The method according to claim 1, further comprising:
acquiring, by the first terminal device, first information, wherein the first information indicates whether a cell on which the first terminal device resides implements paging optimization, and wherein the first information is carried in system information or a System Information Block (SIB).

18. The method according to claim 17, wherein the first information indicates whether the cell on which the first terminal device resides implements paging optimization through one or more of:
a value of a first variable; or
whether a second parameter exists.

19. The method according to claim 16, further comprising:
determining, by the first terminal device, the first paging search spaces, based on the capability of the first terminal device and the first information.

20. A terminal device, comprising:
at least one processor; and
one or more non-transitory computer-readable storage media coupled to the at least one processor and storing programming instructions for execution by the at least one processor, wherein the programming instructions, when executed, cause the terminal device to perform operations comprising:
receiving a first paging message from a network device, wherein the first paging message is carried in first paging search spaces, and the first paging search spaces are determined based on at least one of a capability of the terminal device or whether a cell in which the terminal device resides implements paging optimization.
